(19) United States
(12) Patent Application Publication
(10) Pub. No.: US 2003/0044654 A1
(43) Pub. Date: Mar. 6, 2003

(54) Extending external telephone calls as conference calls with other communicatively proximate wireless devices

(76) Inventor: Laurence E. Holt, London (GB)

Correspondence Address: LAW OFFICES OF MICHAEL DRYJA, 704 228TH AVENUE NE, PMB 694, SAMMAMISH, WA, 98074, US

(21) Appl. No.: 09/682,429

(22) Filed: Aug. 31, 2001

(51) Int. Cl. H04M 3/42; H01M 8/02

(52) U.S. Cl. 429/13; 455/416; 379/158; 429/21

(57) ABSTRACT

Extending external telephone calls as conference calls with other communicatively proximate wireless devices is disclosed. An external call is established between a primary wireless device and a remote device, through a remote master station for the primary wireless device according to a first communication manner. The primary wireless device invites at least one other communicatively proximate wireless device to join the external call according to a second communication manner. For those of the at least one other wireless device that accepted the invitation to join the external call, the primary wireless device extends the external call as a conference call with these devices according to the second communication manner. The extension of the external call as a conference call is accomplished without a local master station, and without the remote master station being aware of the conference call.

### BACKGROUND OF INVENTION

This invention relates generally to wireless devices, and more particularly to such devices that have the capability to establish external telephone calls and to communicate with other such devices that are communicatively proximate.

Mobile wireless devices have become popular for establishing external telephone calls with other devices. Such mobile wireless devices include mobile telephones, such as cellular phones, personal digital assistant (PDA) devices that have integrated or add-on external telephone call capability, as well as other devices. A user establishes an external telephone call by answering his or her mobile wireless device when it rings, or by initiating an external telephone call him or herself. An external telephone call is generally defined as one that is established over an existing telephone network, such as a cellular phone network, a landline phone network, or a combination thereof. The call may be established with another mobile wireless device, or with a more traditional device, such as a telephone commonly found in offices and residences.

A popular feature offered by telephone service providers is the conference call. Conference calls enable more than two parties to participate in a given external telephone call. After an external call is established between an initiating party and a receiving party, the initiating or the receiving party may follow the directions provided by his or her telephone service provider to add other parties to the call. For instance, either party may press a flash or other button on his or her phone, and then dial the phone number of a third party. When the third party answers, this button may be pressed again to patch the third party into the external telephone call, thereby extending the external call into a conference call. This process may be repeated for each additional party that is desired to be added to the conference call.

A disadvantage with such existing conference call technology, however, is that it can become costly for one or both of the original two parties to an external telephone call. For instance, the original initiating party of the external call is typically responsible for long distance and other charges incurred in calling the original receiving party. If the original initiating party then adds other parties to the call, making the external call a conference call, he or she is also typically responsible for long distance and other charges incurred in calling each of these other parties. With long distance phone calls typically costing five-to-fifteen cents a minute for connection to each different party, conference calls can easily exceed fifty cents a minute where many parties are participating in such calls. The initiating party may also have to pay a monthly fee to the telephone service provider to even have conference call capability.

For these and other reasons, therefore, there is a need for the present invention.

### SUMMARY OF INVENTION

The invention relates to extending external telephone calls as conference calls with other communicatively proximate wireless devices. An external telephone call is established between a primary wireless device and a remote device, through a remote master station for the primary wireless device according to a first communication manner. The first communication manner, for instance, may be one or more of analog cellular phone technology, digital cellular phone technology, satellite phone technology, traditional landline phone technology, as well as other technologies. The remote master station may thus be one or more of a telephone company central office, a mobile wireless communication tower, and a communication satellite.

The primary wireless device invites at least one other communicatively proximate wireless device to join the external telephone call according to a second communication manner. The second communication manner, for instance, may be one or more of local wireless networking technology, IEEE 802.11b wireless networking technology, Bluetooth wireless networking technology, as well as other technologies. For those of the at least one other wireless device that accepted the invitation to join the external telephone call, the primary wireless device extends the external call as a conference call with these devices according to the second communication manner. The extension of the external call as a conference call is accomplished without a local master station other than the primary wireless device itself, and without the remote master station being aware of the conference call.

The invention provides for advantages over the prior art. After a party establishes a traditional phone call with his or her cellular phone, for instance, the party can then use the Bluetooth or other capability of the cellular phone to link other parties having cellular phones with similar capability into the phone call, transforming the call into a conference call. The remote master station for the cellular phones, such as the cellular phone tower, and hence the telephone service provider, are unaware that the phone call has been extended into a conference call. The parties thus do not pay any fees to the provider above and beyond those for establishing and maintaining the initial phone call. Still other aspects, advantages, and embodiments of the invention will become apparent by reading the detailed description, and by referring to the accompanying drawings.

### BRIEF DESCRIPTION OF DRAWINGS

FIG. 1 is a diagram of a system according to an embodiment of the invention in which a primary wireless device extends an external telephone call with a remote device into a conference call with other communicatively proximate wireless devices.

FIG. 2 is a diagram of the primary wireless device of FIG. 1 in more detail, according to an embodiment of the invention.

FIG. 3 is a flowchart of a method according to an embodiment of the invention that can be performed by the primary wireless device of FIGS. 1 and 2.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

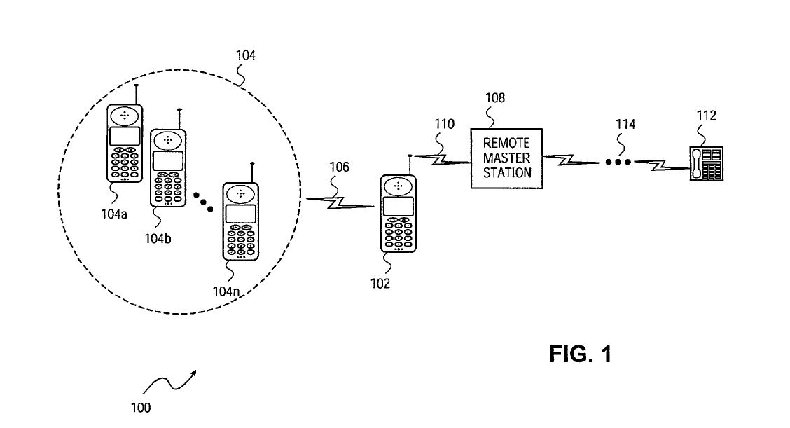

FIG. 1 shows a system 100 according to an embodiment of the invention. The system 100 includes a primary wireless device 102, other wireless devices 104a, 104b, . . . 104n, a remote master station 108, and a remote device 112. The primary wireless device 102 may be a mobile phone, such as a cellular phone, a personal digital assistant (PDA) device with integrated or add-on external telephone call capability, or another type of wireless device, such as a headset-only or a handset-only device. Like the primary wireless device 102, the other wireless devices 104 may each be a cellular phone, a PDA device, or another type of wireless device, such as a headset-only or handset-only device. The primary wireless device 102 is able to communicate with the other wireless devices 104 via a communication manner, as indicated by the bolt 106. Preferably, this communication manner is a local wireless networking technology, such as IEEE 802.11b wireless networking technology, also known as Wi-Fi wireless networking technology, and Bluetooth wireless networking technology.

The primary wireless device 102 is also able to establish external telephone calls through the remote master station 108, as indicated by the bolt 110, such as to the device 112, as indicated by the bolts 114. This ability is through a communication manner other than the communication manner indicated by the bolt 106. For instance, the communication manner may be one or more of analog cellular phone technology, digital cellular phone technology, satellite phone technology, and landline phone technology. In the case of analog or digital cellular phone technology, the remote master station 108 is a wireless communication tower. In the case of satellite phone technology, the remote master station 108 is a satellite. In the case of landline phone technology, the remote master station 108 is a central office. The remote master station 108 is the entity with which the primary wireless device 102 most directly communicates to establish and maintain external telephone calls.

The invention is applicable to the primary wireless device 102 and/or the other wireless devices 104 being other types of devices as well. For instance, these devices may be more stationary, or fixed devices, that are able to communicate in the manner as indicated by the bolt 106. As a more specific example, a cordless telephone, having a handset that is able to communicate in the manner as indicated by the bolt 106 and a local master, or base, station, can act as either the device 102 or one of the wireless devices 104. As another more specific example, a corded telephone that is able to place external calls but that also has the ability to communicate in the manner as indicated by the bolt 106 can also act as either the device 102 or one of the wireless devices 104. Furthermore, either device can be separated into different constituent components, such as individual handset and headset components, even where these components communicate with one another wirelessly.

The device 112 may be a common, corded or cordless, telephone found in office and residential settings, or another type of device 112 that can also establish external telephone calls. For the establishment of an external telephone call between the primary wireless device 102 and the device 112, one of these devices initiates the call, by dialing the phone number of the other device. The other device then typically rings, indicating to the user that a call is being received. The user has the option of answering the telephone call to complete establishment of the external telephone call. Once an external telephone call has been established between the primary wireless device 102 and the device 112, the primary wireless device 102 is able to extend the external call as a conference call to include desired of the other wireless devices 104. The other wireless devices 104 are communicatively proximate to the primary wireless device 102, in that the latter can communicate with each of the former according to the communication manner indicated by the bolt 106. In comparison, the master station 108 and the device 112 are remote.

Extension of the external call between the primary wireless device 102 and the device 112 into a conference call including desired of the other wireless devices 104 is accomplished as follows. The device 102 first performs a discovery process to become aware of the other wireless devices 104, according to the communication manner indicated by the bolt 106. This is because preferably the local wireless network through which the device 102 and the devices 104 communicate is an ad hoc network, such that devices may join and leave the network at any time, as they come into and out of range of the other devices. Once the discovery process is completed, the primary wireless device 102 invites one or more of the devices 104 to join the external call established with the device 112, also according to the communication manner indicated by the bolt 106. Indicators on these devices may notify their users that they have been invited to join the call, and give them the option to accept or decline the invitation. Once the users indicate their decisions, their devices notify the device 102, again by the communication manner indicated by the bolt 106. It is also noted that, in one embodiment, if any of the devices 104 is currently on another call, such devices have the opportunity to extend their conference and/or external calls to the conference call being established by the primary device 102 as well. Assuming that at least some of the invited devices have accepted the invitation to join the external call between the primary wireless device 102 and the device 112, the primary wireless device 102 extends the external call to a conference call including these devices. The device 102 sends any audible signals sent to or received from the device 112 via the communication manner indicated by the bolt 110 to those of the devices 104 that were invited and had accepted invitations to join the call. The device 102 sends these audible signals via the communication manner indicated by the bolt 106. Likewise, the device 102 sends any audible signals sent to or received from these of the devices 104 via the communication manner indicated by the bolt 106 to the device 112, via the communication manner indicated by the bolt 110. In this way, the primary wireless device 102 extends the external call established with the device 112 according to the communication manner indicated by the bolt 110 through the remote master station 108 to a conference call, using the communication manner indicated by the bolt 106.

The extension of an external call into a conference call via the invention is accomplished without a local master station other than the primary wireless device 102, and without the remote master station 108 being aware that the external call has become a conference call. With respect to the former point, there is no local master station that arranges and accommodates the conference call among the other wireless devices 104 and the primary wireless device 102. Rather, the capability to have conference calls is built into the primary wireless device 102 itself. This capability is thus implemented more in a peer-to-peer manner than in a client-server manner. With respect to the latter point, the remote master station 108 is not aware that the other wireless devices 104 are also participating in the external phone call with the remote device 112, in addition to the primary wireless device 102. This is because the device 102 acts as a central point for the conference call, passing any audible signals received from the devices 104 to the device 112, and vice-versa.

It is noted that the above description can be extended to other scenarios to which the invention is also amenable. For example, the local conference call may be initiated prior to the external call being established. However, regardless of the order in which the conference and the external calls are made, the latter can be extended to include the former. Furthermore, in some embodiments of the invention, communicatively proximate wireless devices may join, or request to join, the conference call and/or the external call being governed by the primary wireless device, without having received an explicit invitation from the primary wireless device. As a final example, when the external call that was extended to the local conference call is terminated, the local conference call between the other wireless devices and the primary wireless device may still be intact, or may alternatively also be terminated. In the former case, the primary wireless device may initiate another external call, which is extended to the local conference call as before.

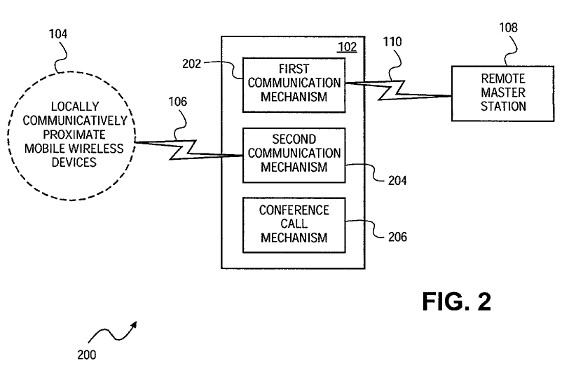

FIG. 2 shows an embodiment of the wireless device 102 of FIG. 1 in more detail. The wireless device 102 includes a first communication mechanism 202, a second communication mechanism 204, and a conference call mechanism 206. Each of the mechanisms 202, 204, and 206 may be software, hardware, or a combination of software and hardware. The communication mechanisms 202 and 204 in particular may also include wireless transceiver capability. Furthermore, each of the mechanisms 202, 204, and 206 may be considered a means for performing its respective functionality. The first communication mechanism 202 allows the device 102 to establish external telephone calls through the remote master station 108, according to a communication manner represented by the bolt 110, as has been described. The second communication mechanism 204 allows the device 102 to communicate with other, communicatively proximate wireless devices 104, according to a communication manner represented by the bolt 106, as has also been described. The conference call mechanism 206 extends external telephone calls established via the first communication mechanism 202 to conference calls with the devices 104 via the second communication mechanism 204.

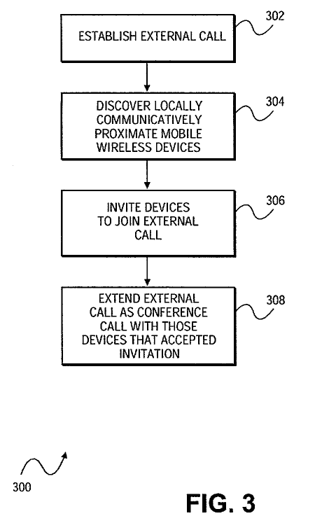

FIG. 3 shows a method 300 that the wireless device 102 of FIGS. 1 and 2 performs in one embodiment. An external telephone call is established between the primary wireless device and a remote device, through a remote master station for the primary wireless device, according to a given communication manner (302). For instance, the primary wireless device may initiate the external call with the remote device, or it may accept the external call as initiated by the remote device. The primary wireless device then discovers any communicatively proximate wireless devices (304). This can be accomplished by the primary wireless device broadcasting a discovery signal, such that any local communicatively proximate wireless devices receive the signal, and correspondingly respond. The primary wireless device receives these responses to become aware of the other wireless devices.

The primary wireless device invites desired ones of the local communicatively proximate wireless devices of which it is aware to join the external call (306). This can be accomplished again by the primary device sending an invite signal to the other devices, such that the other devices respond as to whether or not they wish to join the external call. The primary wireless device finally extends the external call as a conference call with those devices that accept its invitation (308). For voice and other sound communication, such as music, and so on, communicated on the external telephone call with the remote device, the primary wireless device passes such communication onto the conference call with these devices. Similarly, for voice and other sound communication communicated on the conference call with these devices, the primary wireless device passes such communication onto the external telephone call with the remote device.

It is noted that, although specific embodiments have been illustrated and described herein, it will be appreciated by those of ordinary skill in the art that any arrangement is calculated to achieve the same purpose may be substituted for the specific embodiments shown. This application is intended to cover any adaptations or variations of the present invention. Therefore, it is manifestly intended that this invention be limited only by the claims and equivalents thereof.

1. A method comprising:
establishing an external telephone call between a primary wireless device and a remote device through a remote master station for the primary wireless device according to a first communication manner;
inviting at least one other wireless device communicatively proximate to the primary wireless device to join the external telephone call by the primary wireless device according to a second communication manner; and,
for one or more of the at least one other wireless device that have accepted invitation to join the external telephone call, extending the external telephone call as a conference call with the one or more of the at least one other wireless device by the primary wireless device according to the second communication manner, without a local master station other than the primary wireless device and without the remote master station being aware of the conference call.

2. The method of claim 1, wherein establishing the external telephone call between the primary mobile wireless device and the remote device comprises the primary mobile wireless device initiating the external telephone call with the remote device.

3. The method of claim 1, wherein establishing the external telephone call between the primary mobile wireless device and the remote device comprises the primary mobile wireless device accepting the external telephone call as initiated by the remote device.

4. The method of claim 1, further comprising before inviting the at least one other mobile wireless device communicatively proximate to the primary mobile wireless device to join the external telephone call by the primary mobile wireless device,
broadcasting a discovery signal by the primary mobile wireless device; and,
receiving a response to the discovery signal by the primary mobile wireless device from each of the at least one other mobile wireless device, such that the primary mobile wireless device becomes aware of the at least one other mobile wireless device communicatively proximate to the primary mobile wireless device.

5. The method of claim 1, further comprising after inviting the at least one other mobile wireless device communicatively proximate to the primary wireless device to join the external telephone call by the primary wireless device, receiving a response by the primary wireless device from each of the one or more of the at least one other wireless device that desire to join the external telephone call.

6. The method of claim 1, wherein extending the external telephone call as a conference call with the one or more of the at least one other wireless device by the primary wireless device according to the second communication manner comprises:
for first sound communication communicated on the external telephone call according to the first communication manner, also passing the first sound communication onto the conference call according to the second communication manner; and,
for second sound communication communicated on the conference call according to the second communication manner, also passing the second sound communication onto the external telephone call according to the first communication manner.

7. The method of claim 1, wherein the first communication manner comprises at least one of: analog cellular phone technology, digital cellular phone technology, satellite phone technology, and landline phone technology.

8. The method of claim 1, wherein the second communication manner comprises at least one of: local wireless networking technology, IEEE 802.11b wireless networking technology, and Bluetooth wireless networking technology.

9. The method of claim 1, wherein at least one of the primary wireless device and the at least one other wireless device each comprises a mobile phone.

10. The method of claim 1, wherein the remote master station comprises at least one of: a telephone company central office, a wireless communication tower, and a communication satellite.

11. A system comprising:
a primary wireless device having established an external telephone call through a remote master station for the primary wireless device according to a first communication manner; and,
at least one other wireless device communicatively proximate to the primary wireless device according to a second communication manner, the primary wireless device extending the external telephone call as a conference call with the at least one other wireless device according to the second communication manner, without a local master station other than the primary wireless device and without the remote master station being aware of the conference call.

12. The system of claim 11, wherein the first communication manner comprises at least one of: analog cellular phone technology, digital cellular phone technology, satellite phone technology, and landline phone technology.

13. The system of claim 11, wherein the second communication manner comprises at least one of: local wireless networking technology, IEEE 802.11b wireless networking technology, and Bluetooth wireless networking technology.

14. The system of claim 11, wherein at least one of the primary wireless device and the at least one other wireless device each comprises a mobile phone.

15. The system of claim 11, wherein the remote master station comprises at least one of: a telephone company central office, a wireless communication tower, and a communication satellite.

16. A wireless device comprising:
a first communication mechanism to establish an external telephone call through a remote master station according to a first communication manner;
a second communication mechanism to communicate with other wireless devices communicatively proximate according to a second communication manner; and,
a conference call mechanism to extend the external telephone call as a conference call with one or more of the other wireless devices communicatively proximate according to the second communication manner, without a local master station and without the remote master station being aware of the conference call.

17. The wireless device of claim 16, wherein the first communication mechanism comprises means for establishing the external telephone call through the remote master station according to the first communication manner, the second communication mechanism comprises means for communicating with the other wireless devices communicatively proximate according to the second communication manner, and the conference call mechanism comprises means for extending the external telephone call as the conference call with the one or more of the other wireless devices communicatively proximate according to the second communication manner.

18. The wireless device of claim 16, wherein the first communication manner comprises at least one of: analog cellular phone technology, digital cellular phone technology, satellite phone technology, and landline phone technology.

19. The wireless device of claim 16, wherein the second communication manner comprises at least one of: local wireless networking technology, IEEE 802.11b wireless networking technology, and Bluetooth wireless networking technology.

20. The wireless device of claim 16, wherein at least one of the primary wireless device and the at least one other wireless device each is a mobile phone.
